(19) United States
(12) Patent Application Publication
(10) Pub. No.: US 2018/0328890 A1
(43) Pub. Date: Nov. 15, 2018

(54) Non-Destructive Test System with Smart Glasses and Method of Use Thereof

(71) Applicant: CoreStar International Corporation, Irwin, PA (US)

(72) Inventor: Edward Paul Lopez, Ruffs Dale, PA (US)

(21) Appl. No.: 15/976,144

(22) Filed: May 10, 2018

Related U.S. Application Data
(60) Provisional application No. 62/504,008, filed on May 10, 2017.

(51) Int. Cl. G01N 29/06; G02B 27/01; G01N 29/24; G06F 3/01

(52) U.S. Cl. CPC G01N 29/0663; G02B 27/0172; G02B 2027/0178; G06F 3/011; G01N 29/2481

(57) ABSTRACT

A method of non-destructive testing includes providing a non-destructive tester (NDT), including a first processor and a probe/sensor, and smart glasses including a second processor. During movement of the probe/sensor and a specimen under test (SUT) relative to each other, the probe/sensor outputs an interrogation signal into the SUT and acquires a response of the SUT to the interrogation signal. Data corresponding to the response of the SUT is wirelessly communicated from the first processor to the second processor where the data is processed and produced on a display of the smart glasses as a waveform corresponding to the response. The process can be repeated whereupon a first waveform indicative of no defect in the SUT can be displayed when no defect is detected in the SUT and a second waveform indicative of a defect in the SUT can be displayed when a defect is detected in the SUT.

### CROSS REFERENCE TO RELATED APPLICATION

This application claims the benefit of U.S. Provisional Application No. 62/504,008, filed May 10, 2017, the contents of which is incorporated in its entirety herein by reference.

### BACKGROUND OF THE INVENTION

### Field of the Invention

The present invention relates to the field of non-destructive testing, for example, eddy current testing or ultrasound/ultrasonic testing

### Description of Related Art

Eddy current testers can be used in a manner known in the art for inspecting conductive material. Typical uses include inspecting heat exchanger tubing ID, tubing OD, pipe welds, aircraft frame and fuselage, wheel rims, axels, train rails, wire rope, etc. for a defect, such as a crack, where the integrity of the conductive material must be inspected.

Ultrasound or ultrasonic testers can be used in a manner known in the art for inspecting conductive material and non-conductive material, such as, for example, concrete, wood, and composites, for a defect, such as a crack, where the integrity of the material must be inspected.

All existing eddy current testers and ultrasonic testers use the following paradigm: The inspector runs the tester probe along the test part and must look at a separate test instrument, computer, or tablet screen to see the inspection data. This instrument and, if required, display screen, must be carried along and either held or set somewhere within visual range of the inspector.

### SUMMARY OF THE INVENTION

Generally, provided, in one preferred and non-limiting embodiment or example, is a method and system of non-destructive testing that includes, for example, a non-destructive tester (NDT), such as, for example, without limitation, an eddy current tester or an ultrasonic (ultrasound) tester, that includes at least a probe/sensor that can be moved relative to a specimen under test (SUT), and smart glasses that are in wireless communication with each other. The smart glasses can be implemented as a heads-up-display or an augmented reality display in which computer generated images are presented as overlays on the user's field of vision through the glasses.

In one preferred and non-limiting embodiment or example, only two items are required, namely, the smart glasses and the NDT, each of which includes its own processor in wireless communication with each other. No additional processor is required and no tether or physical connection is required between the NDT and the smart glasses.

One advantage of the disclosed method and system is that one hand of a user of the method and system may be completely free. This can be advantageous in a setting where the user may need to climb or get into a position to perform testing on a part under inspection or specimen under test. In this regard, the method and system enhances usability and safety over existing testing methodologies.

Another advantage is that the user can view the part under inspection and the data, e.g., waveforms, generated by the test instrument simultaneously and in real-time (or substantially in real-time). As would be recognized by one skilled in the art, such viewing of the part under inspection and the data, e.g., waveforms, generated by the test instrument simultaneously and in real-time (or substantially in real-time) is subject to processing delays by the processors of the smart glasses and the NDT and delays in wireless communication between said processors. Not needing to look away from the part under inspection during non-destructive testing is expected to improve the quality of the inspection and the safety of the user.

Further preferred and non-limiting embodiments or examples are set forth in the following numbered clauses.

Clause 1: A method comprising: (a) providing a non-destructive tester (NDT) including a first processor and a probe; (b) providing smart glasses including a second processor and a visual display, wherein, when the smart glasses are worn by a user, the visual display is proximate at least one eye of the user; (c) while moving the probe and a specimen under test (SUT) relative to each other (e.g., moving the probe over or proximate to the SUT while the SUT is stationary; moving the SUT over or proximate to the probe while the probe is stationary; or moving the probe proximate to the SUT while the SUT is also moving), the first processor causing the probe to output alternating current (AC) waves into the SUT and to sample via the probe a plurality of responses of the SUT in response to the output AC waves; (d) causing each sampled response of the SUT detected by the first processor in step (c) to be wirelessly communicated to the second processor; and (e) causing the second processor to process each sampled response of the SUT wirelessly communicated in step (d) into a waveform that is produced on the display, wherein: in response to a first sampled response of the SUT to AC waves output into a first region of the SUT in step (c) that does not include a defect, the second processor, in step (e), causing a first waveform indicative of no defect to be produced on the display, and in response to a second sampled response of the SUT to AC waves output into a second region of the SUT that includes a defect in step (c), the second processor, in step (e), causing a second waveform indicative of said defect to be produced on the display.

Clause 2: The method of clause 1, wherein: the defect in the second region of the SUT can be a crack in the SUT; and the SUT in the first region may not include a crack.

Clause 3: The method of clause 1 or 2, wherein: the probe can include a coil; the output AC waves can include an AC magnetic field output by the coil; and the detected response of the SUT can be change in an impedance of the coil.

Clause 4: The method of any one of clauses 1-3, wherein: the probe can include a transducer that outputs ultrasonic AC waves into the SUT; and the detected response of the SUT can include detecting reflection(s) of ultrasonic AC waves from the SUT.

Clause 5: The method of any one of clauses 1-4, wherein the NDT can be an eddy current tester or an ultrasonic (ultrasound) tester.

Clause 6: Also disclosed is a method comprising: (a) providing a non-destructive tester (NDT) including a first processor and a sensor; (b) providing smart glasses including a second processor and a visual display, wherein, when the smart glasses are worn by the user, the visual display is proximate at least one eye of the user; (c) while moving the sensor and a specimen under test (SUT) relative to each other (e.g., moving the sensor over or proximate to the SUT while the SUT is stationary; moving the SUT over or proximate to the sensor while the sensor is stationary; or moving the sensor proximate to the SUT while the SUT is also moving), causing the sensor to output an interrogation signal into the SUT; (d) following step (c), acquiring, by the sensor, a response of the SUT to the interrogation signal; (e) following step (d), wirelessly communicating data corresponding to the response of the SUT acquired in step (d) from the first processor to the second processor; (f) following step (e), processing, with the second processor, the data corresponding to the response of the SUT wirelessly communicated in step (e); (g) following step (f), causing the second processor to produce on the display a waveform corresponding to the response processed in step (f); and (h) repeating steps (c)-(g) one or more times, wherein: a first waveform indicative of no defect in the SUT is displayed in response to a first response acquired in one instance of executing step (d) corresponding to no defect being detected in the SUT, and a second waveform indicative of a defect in the SUT is displayed in response to a second response acquired in another instance of executing step (d) corresponding the defect being detected in the SUT.

Clause 7: The method of clause 6, wherein the interrogation signal can be an AC magnetic field.

Clause 8: The method of clause 6 or 7, wherein the interrogation signal can be ultrasonic waves.

### BRIEF DESCRIPTION OF THE DRAWINGS

These and other features of the present invention will become more apparent from the following description in which reference is made to the appended drawings wherein:

FIG. 1 is block diagram of one preferred and non-limiting embodiment or example test instrument, in the nature of a non-destructive tester, coupled to smart glasses via a wireless communication link;

FIG. 2 is a perspective view of one preferred and non-limiting embodiment or example test instrument and example smart glasses, including the wireless link therebetween, with a probe/sensor of the test instrument positioned proximate a specimen under test;

FIG. 3 is a block diagram of one preferred and non-limiting embodiment or example of the internal elements of the test instrument of FIG. 1;

FIG. 4 is a block diagram of one preferred and non-limiting embodiment or example of the internal elements of the smart glasses of FIG. 1;

FIG. 5 is one preferred and non-limiting embodiment or example flow diagram of a method in accordance with the principles of the present invention;

FIG. 6A is a first example waveform that can be displayed on the display of the smart glasses in response to the sensor of the test instrument not detecting a defect in the specimen under test;

FIG. 6B is a second example waveform that can be displayed on the display of the smart glasses in response to the sensor of the test instrument detecting a defect in the specimen under test;

FIG. 7A is schematic of one preferred and non-limiting embodiment or example of the probe/sensor for an eddy current test instrument that includes a coil for outputting magnetic waves into the specimen under test, wherein said coil experiences a change in impedance in response to the magnetic waves encountering a defect in the specimen under test; and

FIG. 7B is schematic of one preferred and non-limiting embodiment or example of the probe/sensor for an ultrasonic test instrument that includes an ultrasound/ultrasonic transducer which outputs ultrasound waves into the specimen under test and receives reflected ultrasound waves in response to the ultrasound waves input into the specimen under test.

### DESCRIPTION OF THE INVENTION

Various non-limiting examples will now be described with reference to the accompanying figures where like reference numbers correspond to like or functionally equivalent elements.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the invention. Hence, the specific examples or aspects disclosed herein are not to be construed as limiting.

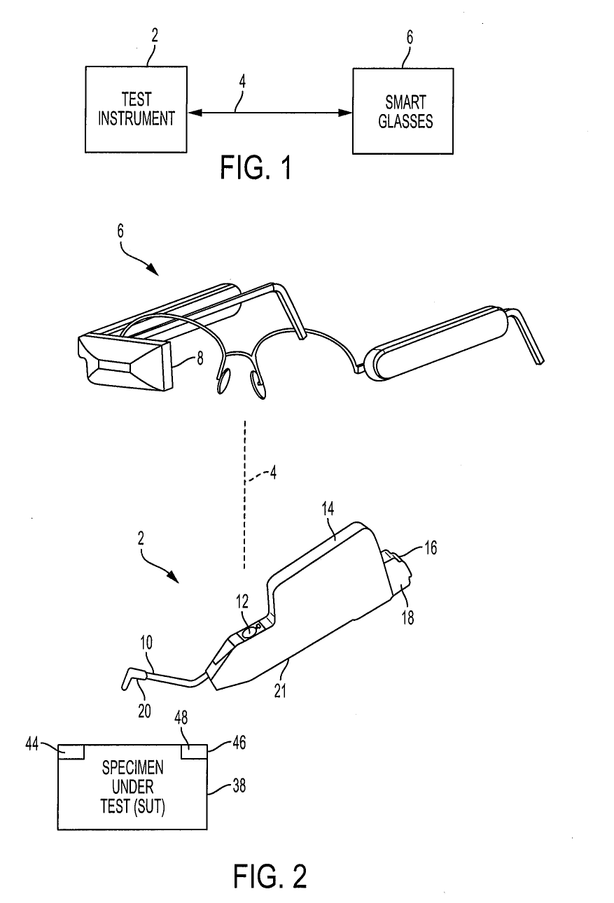

With reference to FIG. 1, in one preferred and non-limiting embodiment or example, a non-destructive test instrument 2 is coupled via a wireless link 4 to smart glasses 6. In an example, instrument 2 can be any suitable and/or desirable non-destructive tester such as, for example, an eddy current tester, an ultrasound tester, and the like. An example hand-held eddy current tester is disclosed is US 2017/0059527, entitled Hand-Held Eddy Current Test Instrument and Sensor, which is incorporated herein by reference.

In one preferred and non-limiting embodiment or example, wireless link 4 can be implemented utilizing any suitable and/or desirable wireless protocol, such as, without limitation, Bluetooth, WiFi, WirelessHD, WiGig, Z-Wave, Zigbee, or any suitable and/or desirable wireless protocol now known or hereinafter developed.

In one preferred and non-limiting embodiment or example, smart glasses 6 can be any suitable and/or desirable heads-up-display technology or augmented reality display now known or hereinafter developed. In an example, smart glasses can be a Vuzix brand M300 Smart Glasses available from Vuzix Corporation of West Henrietta, N.Y. or augmented reality glasses such as a Vuzix brand AR3000 Series Smart Glasses also available from Vuzix Corporation.

With reference to FIG. 2 and continuing reference to FIG. 1, smart glasses implemented as a heads-up-display can include a display 8 which can be positioned proximate one or both eyes of a user wearing the smart glasses. Smart glasses implemented as augmented reality glasses can, in a manner known in the art, display information in an overlay manner on one of more lenses that a user sees-through when the augmented reality glasses are worn. The example smart glasses thus described are not to be construed in a limiting sense since the use of any suitable and/or desirable display technology which is capable of being worn by a user and which can produce a display in the front of or proximate to one or more eyes of a user is envisioned. For the purpose of the follow description, smart glasses 6 will generally be described in connection with a heads-up-display having a single display 8 proximate one eye of a user when the smart glasses are worn by said user. However, this is not to be construed in a limiting sense.

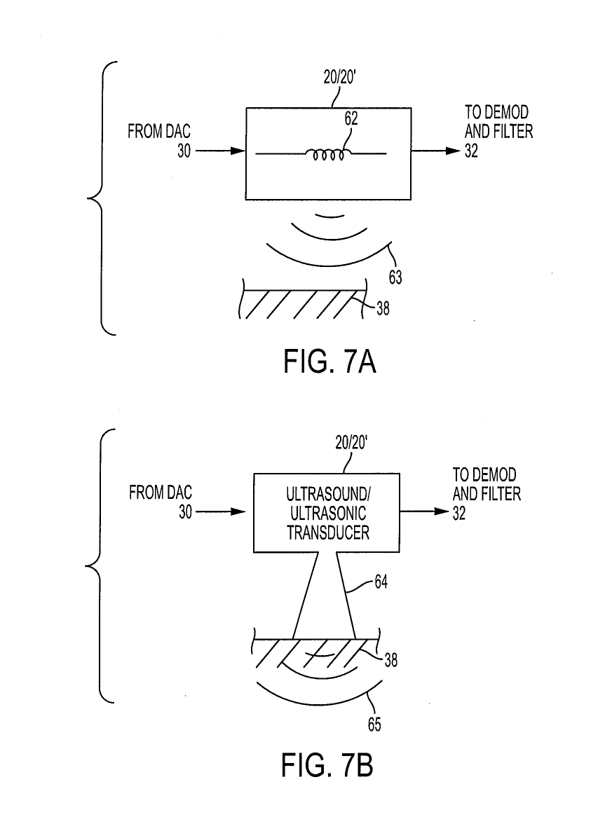

An example non-destructive test instrument 2 in the nature of a hand-held eddy current tester can, in one preferred and non-limiting embodiment or example, include a removable probe tip 10, a control button 12, a fin 14 for housing the electronic components that comprise instrument 2, a power switch 16 on the rear end of instrument 2, a removable cap 18 which can be screwed-off to replace an internal battery (not shown), and a body 21 which houses the battery. In an example, probe tip 10 houses or supports a sensor 20 which, in an example, includes one or more coil(s) 62 (FIG. 7A) that can be used to output into a specimen under test (SUT) 38 an alternating magnetic field 63 (FIG. 7A) that can induce in a SUT 38 eddy currents that can be sampled by said coil(s) 62 in a manner known in the art.

In an example of instrument 2 in the nature of an ultrasound tester, sensor 20 can include an ultrasound/ultrasonic transducer 64 (FIG. 7B) that outputs ultrasonic waves 65 (FIG. 7B) unto SUT 38 and detects reflections of the ultrasonic waves from SUT 38 in a manner known in the art.

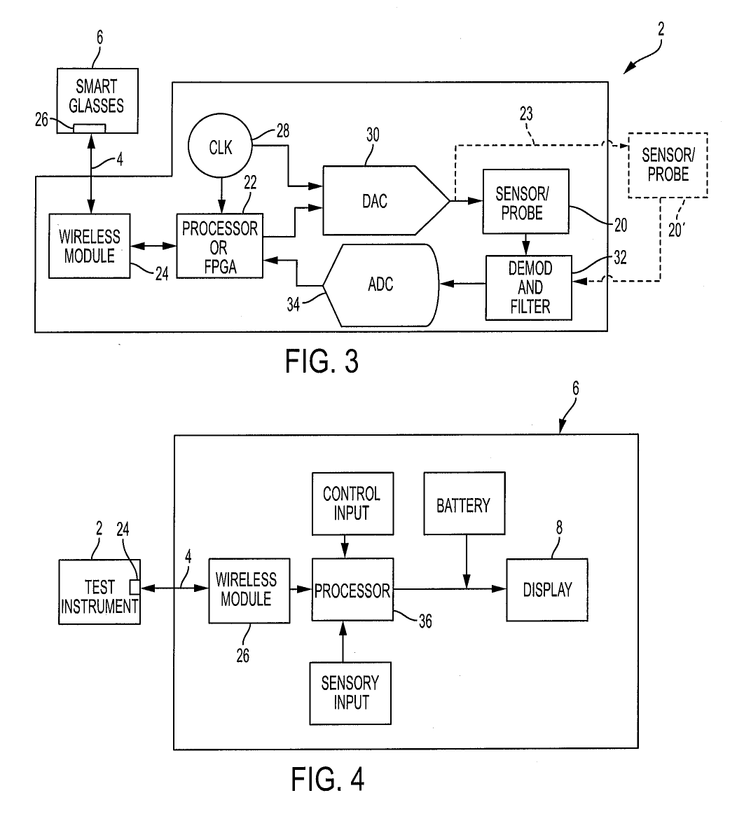

With reference to FIG. 3 and with continuing reference to FIGS. 1 and 2, in one preferred and non-limiting embodiment or example, instrument 2 can include a processor 22, for example, a microprocessor or a FPGA, that can communicate with smart glasses 6 via wireless link 4 formed between wireless modules 24 and 26 of instrument 2 and smart glasses 6, respectively. In an example, wireless link can be a bi-directional link whereupon data can be communicated from test instrument 2 to smart glasses 6 and vice versa. A clock 28 can provide a fixed frequency signal to processor 22 and to a digital-to-analog converter (DAC) 30 as the basis for the timing operations of processor 22 and DAC 30. In one preferred and non-limiting embodiment or example, in a manner known in the art, processor 22 can cause DAC 30 to output to sensor 20 a sine wave of a predetermined frequency.

In the case where instrument 2 is an eddy current tester, in response to this sine wave, coil(s) 62 of sensor 20 can output into SUT 38 an AC magnetic field 63 (FIG. 7A) that induces in SUT 38 (FIG. 2) eddy currents that can be sampled by said coil(s) 62. The signals produced by coil(s) 62 in response to sensing eddy currents in SUT 38 can be processed by a demodulator and filter 32 and presented to an analog-to-digital converter (ADC) 34 that converts the output of demodulator and filter 32 into digital equivalent data which can be received and processed, as needed, by processor 22.

In the case where test instrument 2 is an ultrasound tester, in response to the sine wave output by DAC 30, ultrasound transducer 64 of sensor 20 (FIG. 7B) can output ultrasonic waves 65 (FIG. 7B) into SUT 38 and detects reflections of the ultrasonic waves from SUT 38. The signals produced by ultrasound transducer 64 in response to detecting reflections of ultrasonic waves 65 from SUT 38 can be processed by demodulator and filter 32 and presented to ADC 34 that converts the output of demodulator and filter 32 into digital equivalent data which can be received and processed, as needed, by processor 22.

In one preferred and non-limiting embodiment or example, in the case where test instrument 2 is an ultrasound tester, DAC 30 may not be required for ultrasound transducer 64 of sensor 20 to output ultrasonic waves 65 (FIG. 7B) into SUT 38. Hence, for example, DAC 30 may be replaced by any suitable and/or desirable circuit that can be configured to output one or more pulses to ultrasound transducer 64 of sensor 20 under the control of processor 22, whereupon, in response to the one or more pulses, ultrasound transducer 64 outputs ultrasonic waves into SUT 38. In one non-limiting example, DAC 30 may be replaced a Schmitt trigger. However, this is not to be construed in a limiting sense since DAC 30 may be replaced by any other suitable and/or desirable circuitry now known in the art or hereinafter developed that can drive ultrasound transducer 64 of sensor 20 with one or more pulses under the control of processor 22. Accordingly, the illustration and discussion of DAC 30 herein in connection with ultrasound testing is not to be construed in a limiting sense.

In one preferred and non-limiting embodiment or example, in the case where test instrument 2 is an ultrasound tester, processing of the output of the detected reflections of ultrasonic waves 65 from SUT 38 may not require demodulation. Accordingly, the demodulation function of demodulator and filter 32 may be modified, eliminated, or replaced as needed/required with any suitable and/or desirable circuitry now known in the art or hereinafter developed that enables processing of the detected reflections of ultrasonic waves 65 from SUT 38 in a manner known in the art. Accordingly, the illustration and discussion of demodulator and filter block 32 herein in connection with ultrasound testing is not to be construed in a limiting sense.

In one preferred and non-limiting embodiment or example, processor 22 can be configured to process, as needed, and forward the digital data received from ADC 34 to smart glasses 6 via wireless link 4.

In one preferred and non-limiting embodiment or example of instrument 2 shown in FIG. 3, sensor 20 (which can, in an example, be housed in at least one housing with some or all of the other internal electronic components of instrument 2) can be omitted from said housing and replaced with a sensor 20′ (shown in phantom) that can be coupled to some or all the other internal electronic components of instrument 2 via a cable or wire 23 (also shown in phantom), whereupon sensor 20′ can be moved independent of the other electronic components of instrument 2 housed in the at least one housing. In an example, sensor 20 or 20′ may comprise one or more electronic components that facilitate its operation. Accordingly, the description herein of sensor 20 or 20′ including coil(s) 62 or an ultrasound transducer 64 is not to be construed in a limiting sense.

With reference to FIG. 4 and with continuing reference to all previous figures, the data received by smart glasses 6 via wireless link 4 from test instrument 2 can be processed by a processor 36 of smart glasses 6 as necessary for display of an image on display 8 which, in an example, can be a small screen disposed in front of or proximate to a user's eye when wearing smart glasses 6. In another example, where smart glasses 6 are augmented reality glasses, display 8 can display an image on one or more lenses of the glasses themselves in the field of view of vision of the user when wearing smart glasses 6.

Having thus described one preferred and non-limiting embodiment or example system including test instrument 2, e.g., an eddy current tester or an ultrasonic tester, smart glasses 6, and the wireless link 4 therebetween, a method of operation of the system will now be described.

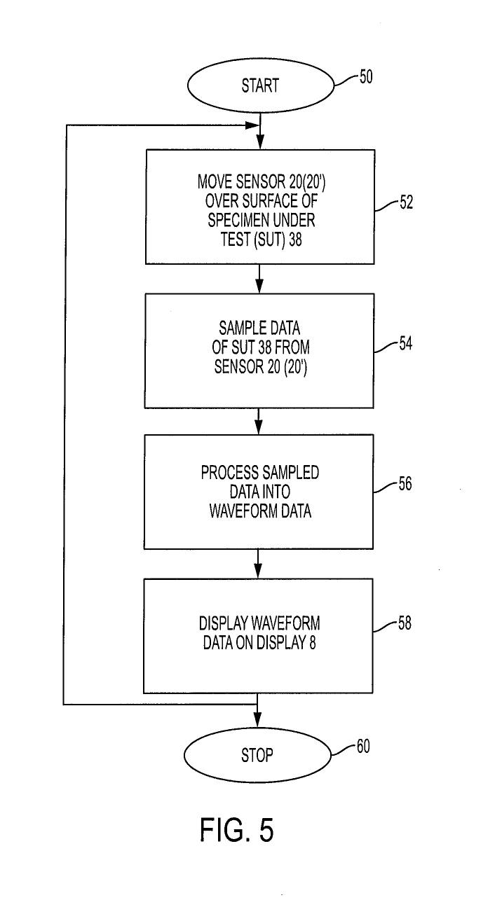

With reference to FIG. 5 and with continuing reference to all previous figures, in one preferred and non-limiting embodiment or example, starting from a state where test instrument 2 and smart glasses 6 are turned on and are in communication via wireless link 4, the method advances from a start step 50 to a step 52 wherein sensor 20 or 20′ is manipulated and moved over a surface of SUT 38. In step 54, data regarding SUT 38 is sampled in real-time (or substantially in real-time) from sensor 20 or 20′ during movement of thereof over the surface SUT 38. In step 56, the sampled data is processed, for example, by at least processor 36 of smart glasses 6, into waveform data. In step 58, this waveform data is then displayed as a waveform on display 8. The loop comprising steps 52-58 can be repeated any number of times as deemed suitable and/or desirable during non-destructive testing of SUT 38 and display 8 can be updated in real-time (or substantially in real-time) to display a waveform for each sample (or some samples) of data acquired of or from one or more portions of SUT 38 along which sensor 20 (or 20′) is moved.

In this manner, during movement of sensor 20 or 20′, waveform(s) corresponding to one or more samples of data acquired (or sampled) by sensor 20 or 20′ of SUT 38 can be displayed in real-time (or substantially in real-time) on display 8. In this manner, a wearer of smart glasses 6 is able to readily determine the location of a defect 48 (FIG. 2) in SUT 38 without having to look away from the location of SUT 38 where sensor 20 or 20′ was positioned when said defect 48 was identified.

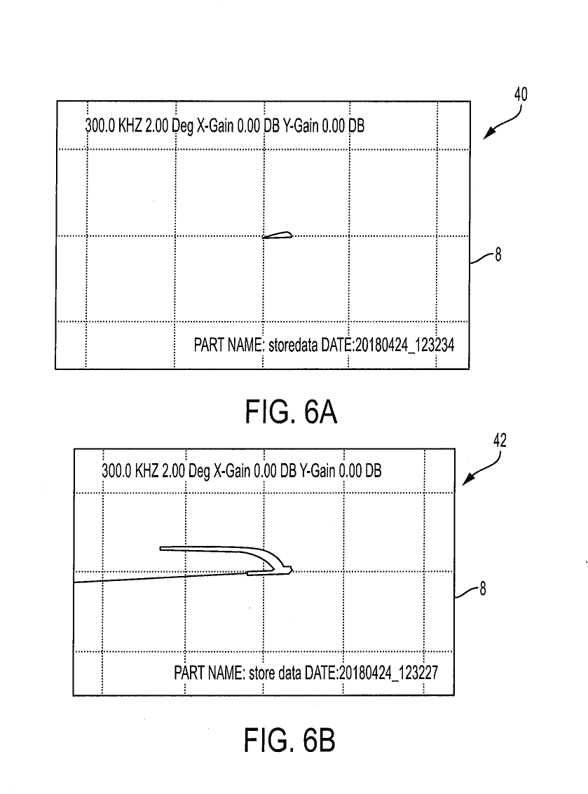

Referring to FIGS. 6A-6B and with continuing reference to all previous figures, in response to sensor 20 or 20′ acquiring a sample from a first region or portion 44 of SUT 38 that does not include a flaw or defect, processor 22, processor 36, or both can process the digital data produced from the sample, whereupon processor 36 can display on display 8 a waveform like waveform 40, for example. In contrast, in response to movement of sensor 20 or 20′ over a second region or portion 46 of SUT 38 that includes a flaw or defect 48, the waveform displayed on display 8 can change, for example, to the waveform 42 shown in FIG. 6B, for example, indicating the presence of the flaw or defect 48 in real-time (or substantially in real-time) with movement of sensor 20 or 20′ proximate to said flaw or defect 48.

As can be seen, by updating display 8 in real-time (or substantially in real-time) with movement of sensor 20 or 20′ over the surface SUT 38, the presence and location of the flaw or defect 48 in SUT 38 can be identified by a user wearing smart glasses 6 and moving sensor 20 or 20′ over the surface of SUT 38. In this manner, a user wearing smart glasses 8 and manipulating sensor 20 or 20′ is able to view the position of sensor 20 or 20′ on or proximate to SUT 38 simultaneously (or substantially simultaneously) viewing a waveform 40 or 42 displayed on display 8 corresponding to the position of sensor 20 or 20′ with respect to SUT 38 in real-time (or substantially in real-time). By being able to observe both the waveform 40 or 42 and the position of sensor 20 or 20′ with respect to SUT 38 when the waveform 42 indicates that a flaw or defect 48 is present, the user wearing smart glasses 6 and manipulating sensor 20 or 20′ can readily pinpoint the location of the flaw or defect 48 without having to look away from SUT 38, as would have been necessary with prior art implementations.

While the above example of non-destructive testing of SUT 38 using sensor 20 or 20′ have been described with reference to moving sensor 20 or 20′ relative to stationary SUT 38, this is not to be construed in a limiting sense since it is envisioned that, in one preferred and non-limiting embodiment or example of non-destructive testing, sensor 20 or 20′ can be stationary and SUT 38 can be moved relative to stationary sensor 20 or 20′. In another preferred and non-limiting embodiment or example, both sensor 20 or 20′ can be moved and SUT 38 can moved relative to each other during non-destructive testing of SUT 38.

As can be seen, disclosed herein is a method displaying eddy current test instrument data in real-time (or substantially in real-time) on a smart glasses based computing device, whether implemented as a heads-up-display or an augmented reality display. The method allows the user or inspector to keep one hand free while scanning the part with the other hand. The method allows the inspector to look at the part under inspection and the inspection results from the test instrument at the same time (or substantially the same time) since the image is displayed in real-time (or substantially in real-time) in the inspector's field of vision. The method can improve the safety of the inspector by keeping one hand free at all times. The method avoids the need for the inspector to look back and forth from the part under inspection (or specimen under test) to a device on which inspection data is displayed.

Also disclosed herein is a method comprising (a) providing a non-destructive tester 2 (NDT) including a first processor 22 and a probe 20 or 20′; (b) providing smart glasses 6 including a second processor 36 and a visual display 8, wherein, when the smart glasses 6 are worn by a user, the visual display 8 is proximate at least one eye of the user; (c) while moving the probe 20 or 20′ and a specimen under test (SUT) 38 relative to each other (e.g., moving the probe over or proximate to the SUT while the SUT is stationary; moving the SUT over or proximate to the probe while the probe is stationary; or moving the probe proximate to the SUT while the SUT is also moving), the first processor 22 causing the probe 20 or 20′ to output alternating current (AC) waves into the SUT 38 and to sample via the probe 20 or 20′ a plurality of responses of the SUT 38 in response to the output AC waves; (d) causing each sampled response of the SUT 38 detected by the first processor 22 in step (c) to be wirelessly communicated 4 to the second processor 36; and (e) causing the second processor 36 to process each sampled response of the SUT 38 wirelessly communicated 4 in step (d) into a waveform 40, 42 that is produced on the display, wherein: in response to a first sampled response of the SUT 38 to AC waves output into a first region 44 of the SUT 38 in step (c) that does not include a defect, the second processor 36, in step (e), causing a first waveform 40 indicative of no defect to be produced on the display 8, and in response to a second sampled response of the SUT 38 to AC waves output into a second region 46 of the SUT that includes a defect 48 in step (c), the second processor 36, in step (e), causing a second waveform 42 indicative of said defect 48 to be produced on the display 8.

The defect 48 in the second region 46 of the SUT 38 can be a crack. The SUT 38 in the first region 44 may not include a crack.

The probe 20 or 20′ can include a coil 62 (FIG. 7A). The output AC waves can include an AC magnetic field output by the coil 62. The detected response of the SUT 38 can be a change in an impedance of the coil 62.

The probe 20 or 20′ can include a transducer 64 (FIG. 7B) that outputs ultrasonic AC waves into the SUT 38. The detected response of the SUT 38 can include detecting reflection(s) of ultrasonic AC waves from the SUT 38.

The NDT 2 can be an eddy current tester or an ultrasonic (ultrasound) tester.

Also disclosed herein is a method comprising: (a) providing a non-destructive tester (NDT) 2 including a first processor 22 and a sensor 20 or 20′; (b) providing smart glasses 6 including a second processor 36 and a visual display 8, wherein, when the smart glasses 6 are worn by the user, the visual display 8 is proximate at least one eye of the user; (c) while moving the NDT 2 and a specimen under test (SUT) 38 relative to each other (e.g., moving the NDT over or proximate to the SUT while the SUT is stationary; moving the SUT over or proximate to the NDT while the NDT is stationary; or moving the NDT proximate to the SUT while the SUT is also moving), causing the sensor 20 or 20′ to output an interrogation signal 63 (FIG. 7A) or 65 (FIG. 7B) into the SUT 38; (d) following step (c), acquiring, by the sensor 20 or 20′, a response of the SUT 38 to the interrogation signal; (e) following step (d), wirelessly 4 communicating data corresponding to the response of the SUT 38 acquired in step (d) from the first processor 22 to the second processor 36; (f) following step (e), processing, with the second processor 36, the data corresponding to the response of the SUT 38 wirelessly communicated in step (e); (g) following step (f), causing the second processor 36 to produce on the display 8 a waveform 40,42 corresponding to the response processed in step (f); and (h) repeating steps (c)-(g) one or more times, wherein: a first waveform 40 indicative of no defect in the SUT 38 is displayed on the display 8 in response to a first response acquired in one instance of executing step (d) corresponding to no defect being detected in the SUT 38, and a second waveform 42 indicative of a defect 48 in the SUT 38 is displayed on the display 8 in response to a second response acquired in another instance of executing step (d) corresponding the defect being detected in the SUT.

The interrogation signal can be an AC magnetic field 63.

The interrogation signal can be ultrasonic waves 65.

Although the invention has been described in detail for the purpose of illustration based on what is currently considered to be the most practical preferred and non-limiting embodiments, examples, or aspects, it is to be understood that such detail is solely for that purpose and that the invention is not limited to the disclosed preferred and non-limiting embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

The invention claimed is:

1. A method comprising:
(a) providing a non-destructive tester (NDT) including a first processor and a probe;
(b) providing smart glasses including a second processor and a visual display, wherein, when the smart glasses are worn by a user, the visual display is proximate at least one eye of the user;
(c) while moving the probe and a specimen under test (SUT) relative to each other, the first processor causing the probe to output alternating current (AC) waves into the SUT and to sample via the probe a plurality of responses of the SUT in response to the output AC waves;
(d) causing each sampled response of the SUT detected by the first processor in step (c) to be wirelessly communicated to the second processor; and
(e) causing the second processor to process each sampled response of the SUT wirelessly communicated in step (d) into a waveform that is produced on the display, wherein:
in response to a first sampled response of the SUT to AC waves output into a first region of the SUT in step (c) that does not include a defect, the second processor, in step (e), causing a first waveform indicative of no defect to be produced on the display, and
in response to a second sampled response of the SUT to AC waves output into a second region of the SUT that includes a defect in step (c), the second processor, in step (e), causing a second waveform indicative of said defect to be produced on the display.

2. The method of claim 1, wherein:
the defect in the second region of the SUT is a crack; and
the SUT in the first region does not include a crack.

3. The method of claim 1, wherein:
the probe includes a coil;
the output AC waves include an AC magnetic field output by the coil; and
the detected response of the SUT is a change in an impedance of the coil.

4. The method of claim 1, wherein:
the probe includes a transducer that outputs ultrasonic waves into the SUT; and
the detected response of the SUT includes detecting reflection(s) of ultrasonic waves from the SUT.

5. The method of claim 1, wherein the probe is one of an eddy current tester and an ultrasonic tester.

6. A method comprising:
(a) providing a non-destructive tester (NDT) including a first processor and a sensor;
(b) providing smart glasses including a second processor and a visual display, wherein, when the smart glasses are worn by a user, the visual display is proximate at least one eye of the user;
(c) while moving the sensor and a specimen under test (SUT) relative to each other, causing the sensor to output an interrogation signal into the SUT;
(d) following step (c), acquiring, by the sensor, a response of the SUT to the interrogation signal;
(e) following step (d), wirelessly communicating data corresponding to the response of the SUT acquired in step (d) from the first processor to the second processor;
(f) following step (e), processing, with the second processor, the data corresponding to the response of the SUT wirelessly communicated in step (e);
(g) following step (f), causing the second processor to produce on the display a waveform corresponding to the response processed in step (f); and
(h) repeating steps (c)-(g) one or more times, wherein:
a first waveform indicative of no defect in the SUT is displayed in response to a first response acquired in one instance of executing step (d) corresponding to no defect being detected in the SUT, and
a second waveform indicative of a defect in the SUT is displayed in response to a second response acquired in another instance of executing step (d) corresponding a defect being detected in the SUT.

7. The method of claim 6, wherein the interrogation signal is an AC magnetic field.

8. The method of claim 6, wherein the interrogation signal is ultrasonic wave.
